(19) United States
(12) Patent Application Publication
(10) Pub. No.: US 2025/0031247 A1
(43) Pub. Date: Jan. 23, 2025

(54) DEVICE AND METHOD FOR SPATIAL REUSE IN WIRELESS NETWORK ENVIRONMENT

(71) Applicant: UIF (University Industry Foundation), Yonsei University, Seoul (KR)

(72) Inventors: Jong-Moon CHUNG, Seoul (KR); Jae Wook JUNG, Paju-si (KR); Jung Suk BAIK, Seoul (KR)

(21) Appl. No.: 18/778,015

(22) Filed: Jul. 19, 2024

(30) Foreign Application Priority Data
Jul. 20, 2023 (KR) 10-2023-0094401

(51) Int. Cl. H04W 74/0816; H04W 84/12

(52) U.S. Cl. CPC H04W 74/0816; H04W 84/12

(57) ABSTRACT

Provided are a device and method for spatial reuse in a wireless network. According to the device and method for spatial reuse, concurrent transmission power is calculated that is a power for transmitting a signal concurrently with an occupant transmission node, which is occupying a channel and transmitting a signal with reference transmission power, on the basis of a density of nearby access points (APs), a clear channel assessment (CCA) threshold is adjusted and set in accordance with the concurrent transmission power, and whether to perform concurrent transmission is determined in accordance with the CCA threshold and an intensity of the signal transmitted by the occupant transmission node. Accordingly, it is possible to efficiently reuse space.

### CROSS-REFERENCE TO RELATED APPLICATION

This application claims priority under 35 U.S.C. § 119 (a) to and the benefit of Korean Patent Application No. 2023-0094401, filed on Jul. 20, 2023, the disclosure of which is incorporated herein by reference in its entirety.

### BACKGROUND

### 1. Field of the Invention

The present disclosure relates to a device and method for spatial reuse in a wireless network environment.

### 2. Discussion of Related Art

Among wireless networks, the Institute of Electrical and Electronics Engineers (IEEE) 802.11 wireless local area network (WLAN) is being standardized as IEEE 802.11be (Wi-Fi 7) after IEEE 802.11ax (Wi-Fi 6) which is published on May of 2021. The IEEE 802.11be (Wi-Fi 7) standard aims for a transmission rate of 30 Gbps or higher to ensure a high level of quality of service, and functions, such as 4096 quadrature amplitude modulation (QAM), multi-radio unit (RU), and the like, will be added to achieve this. The IEEE 802.11be (Wi-Fi 7) standard aims for publication in 2024, followed by the IEEE 802.11bn (Wi-Fi 8) standard.

For channel occupancy, IEEE 802.11 WLANs employ a distribution coordination function (DCF) of a carrier sense multiple access/collision avoidance (CSMA/CA) scheme. Accordingly, when a measured energy strength (or power strength) based on a clear channel assessment (CCA) threshold prior to DCF transmission is less than the CCA threshold, the channel is determined to be idle, and transmission is performed. On the other hand, when a measured energy strength is larger than the CCA threshold, the channel is determined to be in use, and transmission is put on hold. However, parameters used in current DCF schemes are set conservatively, which limits the efficient use of space in an environment in which terminals are densely present.

Therefore, IEEE 802.11be (Wi-Fi 7) networks are going to introduce a coordinated spatial reuse (CSR) technique to the standard that coordinates between access points (APs) to determine transmission power for efficient space utilization. The CSR technique improves spatial transmission performance by regulating the transmission power through coordination between APs but has the disadvantage of adding overhead to the system due to exchange of control frames, link information, transmission power, and the like.

A spatial reuse technique was first included in the standard of IEEE 802.11ax (Wi-Fi 6) networks. The spatial reuse technique included in IEEE 802.11ax (Wi-Fi 6) networks is an overlapping basic service set packet duplication (OBSS_PD)-based spatial reuse technique, which works without any optimization or performance considerations simply by providing a boundary value (−62 dBm to −82 dBm) for the OBSS level coordination for a CCA threshold, adjusting the OBSS level between the boundary values, and adjusting transmission power accordingly. Therefore, performance is degraded.

Meanwhile, as the Internet of things (IoT) becomes more prevalent in everyday products, the number of nodes utilizing the IEEE 802.11 WLAN protocol is growing exponentially, and efficient use of space is necessary to ensure the performance of these nodes. Therefore, for efficient space utilization, it is necessary to determine transmission power by exchanging few frames in consideration of interference or a transmission success rate.

### SUMMARY OF THE INVENTION

The present disclosure is directed to providing a device and method for spatial reuse which maximize a success rate of concurrent transmission with existing transmission by adjusting transmission power on the basis of the density of nearby access points (APs).

The present disclosure is also directed to providing a device and method for spatial reuse which allow efficient spatial reuse by adjusting a clear channel assessment (CCA) threshold adaptively to determined transmission power.

The present disclosure is also directed to providing a device and method for spatial reuse which may improve performance through spatial reuse while preventing an increase in system overhead by exchanging few frames.

According to an aspect of the present disclosure, there is provided a device for spatial reuse included in a transmission node of a wireless network, the device including a memory and a processor configured to execute at least some of operations based on a program stored in the memory. The processor calculates concurrent transmission power that is a power for transmitting a signal concurrently with an occupant transmission node, which is occupying a channel and transmitting a signal with reference transmission power, on the basis of a density of nearby APs, adjusts and sets a clear channel assessment (CCA) threshold in accordance with the concurrent transmission power, and determines whether to perform concurrent transmission in accordance with the CCA threshold and an intensity of the signal transmitted by the occupant transmission node.

The processor may calculate and acquire the concurrent transmission power for maximizing a product of a transmission success possibility of the occupant transmission node and a concurrent transmission success possibility which is a transmission success possibility of concurrent transmission.

When the concurrent transmission power is not within a standard transmission power range, the processor may cause the transmission node to not perform concurrent transmission by suspending transmission.

When a signal intensity transmitted by the occupant transmission node is the CCA threshold or less, the processor may cause the transmission node to perform concurrent transmission.

When the occupant transmission node is an internal basic service set (BSS) node constituting a BSS with the transmission node, the processor may set a reference CCA threshold as the CCA threshold.

When the occupant transmission node is an external BSS node constituting a different BSS than the transmission node, the processor may set the CCA threshold such that a sum of the concurrent transmission power and a minimum CCA threshold equals a sum of the reference transmission power and the CCA threshold.

The processor may check the density of the nearby APs on the basis of BSS information which is periodically exchanged between the APs and acquired.

The processor may determine whether the occupant transmission node is an internal BSS node included in the same BSS as the transmission node or an external BSS node included in a different BSS than the transmission node on the basis of BSS color information included in BSS information which is periodically exchanged between the APs and acquired.

The transmission node may be implemented as a device for occupying the channel using a distribution coordination function (DCF) of a carrier sense multiple access/collision avoidance (CSMA/CA) scheme based on Institute of Electrical and Electronics Engineers (IEEE) 802.11.

According to another aspect of the present disclosure, there is provided a method for spatial reuse performed by a processor included in a transmission node of a wireless network, the method including calculating concurrent transmission power that is a power for transmitting a signal concurrently with an occupant transmission node, which is occupying a channel and transmitting a signal with reference transmission power, on the basis of a density of nearby APs, adjusting and setting a CCA threshold in accordance with the concurrent transmission power, and determining whether to perform concurrent transmission according to the CCA threshold and an intensity of the signal transmitted by the occupant transmission node.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram illustrating the concept of a method for spatial reuse in a wireless network system according to an exemplary embodiment;

FIG. 2 is a schematic block diagram of a device for spatial reuse according to an exemplary embodiment of the present invention;

FIG. 3 is a diagram illustrating a frame header for using an overlapping basic service set packet duplication (OBSS_PD)-based spatial reuse technique according to an exemplary embodiment;

FIG. 4 is a flowchart illustrating a method for spatial reuse in a wireless network system according to an exemplary embodiment; and

FIG. 5 is a diagram illustrating a computing environment including a computing device according to an exemplary embodiment.

### DETAILED DESCRIPTION OF EXEMPLARY EMBODIMENTS

Hereinafter, specific embodiments of the present disclosure will be described with reference to the drawings. The following detailed description is provided to help a comprehensive understanding of a method, a device, and/or a system described in this specification. However, this is only an example, and the present invention is not limited thereto.

In describing embodiments of the present disclosure, when it is determined that detailed description of well-known technologies related to the present invention may unnecessarily obscure the gist of embodiments, the detailed description will be omitted. Terms to be described below are terms defined in consideration of functions in the present invention, and may vary depending on the intention, practice, or the like of a user or operator. Therefore, the terms should be defined on the basis of the overall content of this specification. Terms used in the detailed description are only used to describe embodiments and should not be construed as limiting. Unless otherwise clearly specified, a singular expression includes the plural meaning. In this description, an expression such as “include” or “have” is intended to indicate certain features, numerals, steps, operations, elements, or some or combinations thereof, and should not be construed as excluding the presence or possibility of one or more other features, numerals, steps, operations, elements, or some or combinations thereof. Also, the terms “unit,” “device,” “module,” “block,” and the like described in this specification refer to units for processing at least one function or operation, which may be implemented by hardware, software, or a combination of hardware and software.

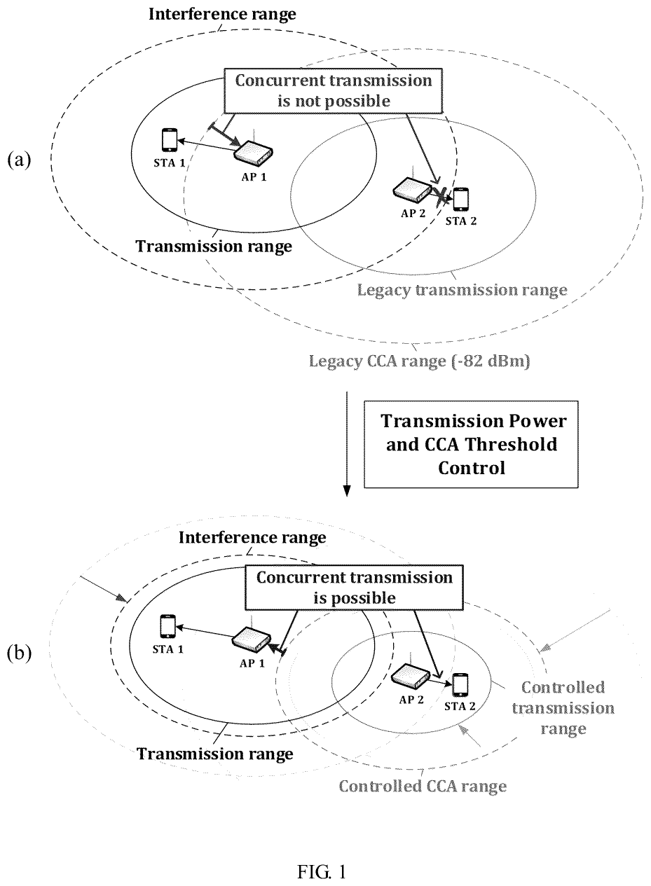

FIG. 1 is a diagram illustrating the concept of a method for spatial reuse in a wireless network system according to an exemplary embodiment. The wireless network system of FIG. 1 may be, for example, an Institute of Electrical and Electronics Engineers (IEEE) 802.11 wireless local area network (WLAN) system.

Referring to FIG. 1, the wireless network system may include basic service sets (BSSs). The BSSs include access points (APs) AP1 and AP2 and may further include stations STA1 and STA2 that access a network through the APs AP1 and AP2 included in the BSSs. In other words, the APs AP1 and AP2 may provide a communication service to the stations STA1 and STA2 included in the same BSSs. Although it has been illustrated that each of the first and second BSSs only includes one of the APs AP1 and AP2 and one of the stations STA1 and STA2, each BSS may include a plurality of APs and a plurality of stations.

The APs AP1 and AP2 and the stations STA1 and STA2 are devices that may perform communication using the medium access control (MAC) protocol based on IEEE 802.11. The APs AP1 and AP2 may also be referred to as “routers” or “gateways,” and the stations STA1 and STA2 may also be referred to as “subscribers,” “terminals,” or “user equipment.” The stations STA1 and STA2 may be implemented as mobile devices, such as smartphones, or various devices such as personal computers (PCs), smart televisions (TVs), or the like.

In FIG. 1, the first AP AP1 may constitute the first BSS to provide the communication service to the first station STA1, and the second AP AP2 may constitute the second BSS to provide the communication service to the second station STA2. Since a BSS is a logical element rather than a physical service area, the size of a BSS area in which each of the APs AP1 and AP2 communicates with one of the stations STA1 and STA2 included in the same BSS may be adjusted variously depending on the communication environment. As shown in FIG. 1, different BSSs may overlap such that an overlapping basic service set (OBSS) may be generated.

In a network environment in which the OBSS is generated, when transmission nodes of the different BSSs (i.e., the APs AP1 and AP2 and the stations STA1 and STA2) concurrently perform communication, mutual interference may occur. As an example, when the second AP AP2 concurrently transmits a signal to the second station STA2 while the first AP AP1 of the first BSS transmits a signal to the first station STA1, a collision may occur.

IEEE 802.11 WLANs employ a distribution coordination function (DCF) of a carrier sense multiple access/collision avoidance (CSMA/CA) scheme for channel occupation. Therefore, while a transmission node of a first BSS transmits a signal, a transmission node of a second BSS suspends transmission without transmitting a signal. Subsequently, the transmission node of the second BSS may occupy a channel through contention and then transmit the signal. In this case, performance of the wireless network, that is, transmission efficiency, is degraded.

In the example shown in FIG. 1A, the second AP AP2 and the second station STA2 are outside a transmission range in which the first AP AP1 transmits a signal to the first station STA1, and similarly, the first AP AP1 and the first station STA1 are outside a transmission range in which the second AP AP2 transmits a signal to the second station STA2. Accordingly, considering only a transmission range without other factors, when the first and second APs AP1 and AP2 adjust their transmission powers appropriately to reduce the size of the area where transmission ranges overlap as shown in FIG. 1B, the second AP AP2 may concurrently transmit a signal to the second station STA2 while the first AP AP1 transmits a signal to the first station STA1. The above technique for allowing concurrent signal transmission by adjusting the transmission powers of the APs AP1 and AP2 of the different BSSs is referred to as a “spatial reuse technique.”

In wireless networks according to the related art, as shown in the example of FIG. 1, when the second AP AP2 attempts to transmit a signal to the second station STA2 while the first AP AP1 transmits a signal to the first station STA1, the second AP AP2 checks a CCA range which is a criterion for an interference range irrespective of transmission power on the basis of a CCA threshold which is set according to an OBSS packet duplication (OBSS_PD) technique already introduced in IEEE 802.11ax (Wi-Fi 6).

Also, as shown in FIG. 1A, when it is determined that another AP (here, the first AP AP1) is within the checked CCA range, the second AP AP2 cannot transmit a signal to the second station STA2 irrespective of whether transmission power is adjusted. This is because the first AP AP1 is within the CCA range of the second AP AP2 and it is determined that, when the second AP AP2 transmits a signal to the second station STA2, this will cause interference to the communication between the first AP AP1 and the first station STA1.

However, in wireless networks according to the related art, a CCA threshold is set to a fixed value, resulting in a very wide CCA range. IEEE 802.11ax (Wi-Fi 6) specifies that a CCA threshold may be adjusted and set in the range of −62 dBm to −82 dBm, but provides no rules for adjusting a CCA threshold. Also, in wireless networks according to the related art, an interference range is considered in a very conservative view to set a CCA threshold to a fixed value of −82 dBm. In other words, a CCA range is interpreted as widely as possible.

If the second AP AP2 determines whether transmission is possible using a CCA range which is as widely interpreted as in FIG. 1A, even when the second AP AP2 adjusts its transmission power such that its transmission range does not overlap the transmission range of the first AP AP1 as shown in FIG. 1B, the second AP AP2 cannot transmit a signal to the second station STA2 while the first AP AP1 transmits a signal. In other words, efficiency of a wireless network is degraded.

To solve this problem, the present disclosure provides rules for adjusting a CCA threshold in the range of −62 dBm to −82 dBm in accordance with the standard of IEEE 802.11ax (Wi-Fi 6). In other words, the present disclosure makes it possible to adaptively adjust a CCA threshold within the range in accordance with the standard of IEEE 802.11ax (Wi-Fi 6).

When a CCA threshold is adaptively varied to adjust a CCA range which is a criterion for interference as shown in FIG. 1B, the second AP AP2 may adjust its transmission power to concurrently transmit a signal to the second station STA2 while the first AP AP1 transmits a signal. Accordingly, it is possible to improve wireless network efficiency. In this case, the first AP AP1 may also vary its CCA threshold adaptively and independently of the second AP AP2 to adjust its interference range. Since another AP (here, the second AP AP2) is not within the adjusted interference range, the first AP AP1 can transmit a signal to the first station STA1 irrespective of whether the second AP AP2 performs communication.

As described above, in the present disclosure, the APs AP1 and AP2 of BSSs adjust their CCA thresholds to vary their CCA ranges.

To this end, in the present disclosure, each of the APs AP1 and AP2 of the BSSs checks a density A of nearby APs first. Then, each of the APs AP1 and AP2 determines its transmission power for increasing a transmission success rate even in concurrent transmission on the basis of the checked density λ in consideration of effects of mutual interference. Here, the APs AP1 and AP2 may independently determine their transmission power without additionally exchanging control frames, link information, transmission power, and the like for mutual coordination. In other words, each of the APs AP1 and AP2 determines its transmission power and CCA threshold using a non-coordination method, minimizing system overhead occurring for coordination.

Also, each of the APs AP1 and AP2 adjusts and determines its CCA threshold adaptively to the determined transmission power. When the CCA threshold is adaptively adjusted with the transmission power, a transmission path between the AP AP1 or AP2 and the station STA1 or STA2 of the other BSS is not within the transmission range or the CCA range as shown in FIG. 1B. Accordingly, transmission of different BSSs can concurrently transmit signals.

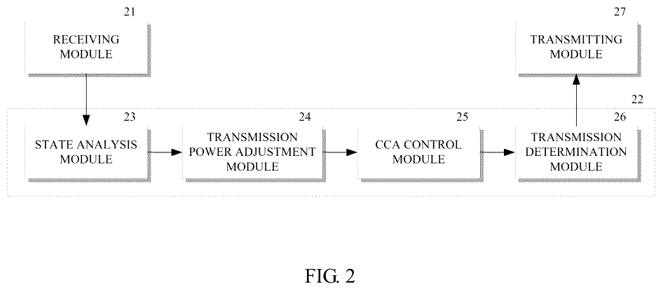

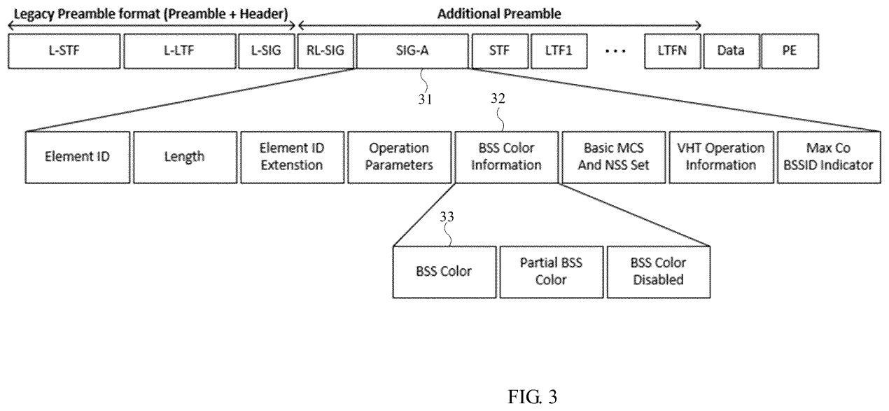

FIG. 2 is a block diagram in which a device for spatial reuse according to an exemplary embodiment is schematically divided by operations being performed, and FIG. 3 is a diagram illustrating a frame header for using an OBSS_PD-based spatial reuse technique according to an exemplary embodiment.

In the present disclosure, a device for spatial reuse may be included in the APs AP1 and AP2. Here, a device for spatial reuse which is included in the second AP AP2 and attempts concurrent transmission while the first AP AP1 is occupying a channel will be described as an example. Like in FIG. 1, the first AP AP1 transmits a frame to the first station STA1, and the device for spatial reuse of the second AP AP2 determines whether to transmit a frame to the second station STA2, transmission power, and a CCA threshold while the first AP AP1 is transmitting the frame to the first station STA1.

Specifically, the device for spatial reuse according to the present disclosure may include a receiving module 21, a transmission adjustment module 22, and a transmitting module 27.

The receiving module 21 receives a signal (or a frame) transmitted by a server, a nearby AP (in this case, AP1), or the station STA1 included in the same BSS as the device for spatial reuse. Here, the receiving module 21 may measure an intensity of the received signal and transmit the measured intensity to the transmission adjustment module 22.

Also, the receiving module 21 may transmit BSS information in a signal which is periodically transmitted by the nearby APs AP1 to the transmission adjustment module 22. Here, the BSS information may be transmitted in the form of a beacon frame as an example and include information about whether to use the spatial reuse technique and transmission power of the nearby BSS, that is, reference transmission power P_{N} which is transmission power of a station or an AP that is a transmission node of the nearby BSS. Also, as shown in FIG. 3, a BSS color information field 32 for identifying the BSS of the device that has transmitted the signal may be included in a SIG-A field 31 of a frame header and transmitted as the BSS information.

The transmission adjustment module 22 analyzes the density λ of the nearby APs AP1 and determines concurrent transmission power P_{C} for performing concurrent transmission while the nearby APs AP1 performs transmission in accordance with the analyzed density λ using the spatial reuse technique. Then, the transmission adjustment module 22 determines a CCA threshold in accordance with the determined concurrent transmission power P_{C} and determines whether to transmit a frame to the second station STA2 on the basis of the determined CCA threshold.

The transmission adjustment module 22 may include a state analysis module 23, a transmission power adjustment module 24, a CCA control module 25, and a transmission determination module 26. The state analysis module 23 first analyzes the BSS information transmitted by the nearby APs AP1 to check the density λ of the nearby APs AP1.

The transmission power adjustment module 24 calculates the concurrent transmission power P_{C} for performing concurrent transmission with the nearby AP AP1 in accordance with the spatial reuse technique, on the basis of the density λ of the nearby APs AP1 checked by the state analysis module 23. Here, the transmission power adjustment module 24 calculates the concurrent transmission power P_{C} to maximize transmission success possibilities of the device for spatial reuse and the occupant transmission node of the nearby BSS which is occupying the channel and transmitting a signal.

When concurrent transmission is performed while the occupant transmission node (e.g., the first AP AP1) performs transmission, a transmission success possibility [symbol] (γ_{c}>γₜₕ) may be calculated as shown in Equation 1.

$$[ Equation 1 ]$$

$$ℙ ( {γ}_{c} > {γ}_{th} ) = 1 - exp ( - \frac{sin c ( 2 / α ) \text{?}}{( {γ}_{th} {P}_{N} \text{?}} ( 1 - exp ( \frac{π λ ( {γ}_{th} {P}_{N} \text{?}}{sin c ( 2 / α ) \text{?}} ) ) )$$

$$\text{?} \text{indicates text missing or illegible when filed}$$

Here, α is a path loss parameter, γₜₕ is a signal-to-noise ratio (SINR) threshold for successful transmission, and P_{N} is transmission power of the occupant transmission node that is transmitting a signal in a nearby BSS. Also, Pₜₕ is a received signal strength indicator (RSSI) threshold for successful transmission, and sinc ( ) is a sinc function.

When concurrent transmission is performed, a transmission success possibility [symbol] (γ_{N}>γₜₕ) of the occupant transmission node that is transmitting a signal in the nearby BSS may be calculated as shown in Equation 2.

$$ℙ ( {γ}_{N} > {γ}_{th} ) = \frac{1}{1 + \frac{{γ}_{th} {{P}_{C} ( 2 \sqrt{λ} )}^{α}}{{P}_{th}}} exp ( - \frac{{πλ ( {γ}_{th} {P}_{N} )}^{2 / α}}{sin c ( 2 / α ) {P}_{th}^{2 / α}} ) \qquad [ Equation 2 ]$$

To calculate concurrent transmission power P_{C} for maximizing the transmission success possibilities [symbol] (γ_{c}>γₜₕ) and [symbol] (γ_{N}>γₜₕ) of the device for spatial reuse and the occupant transmission node of the nearby BSS which are calculated in accordance with Equations 1 and 2, an object function [symbol] (P_{C}) may be configured as shown in Equation 3.

$$[ Equation 3 ]$$

$$𝕊 ( \text{?} ) = ℙ ( \text{?} > \text{?} ) ℙ ( \text{?} > \text{?} ) = [ 1 - exp ( - \frac{\text{?}}{\text{?}} ( 1 - exp ( - \frac{\text{?}}{\text{?}} ) ) ) ] [ \frac{1}{1 + \frac{\text{?}}{\text{?}}} exp ( - \frac{\text{?}}{\text{?}} ) ]$$

$$\text{?} \text{indicates text missing or illegible when filed}$$

Accordingly, the transmission power adjustment module 24 may acquire the concurrent transmission power P_{C} by solving an optimization problem of maximizing the object function [symbol] (P_{C}) of Equation 3.

However, it is necessary to solve the optimization problem of maximizing the object function [symbol] (P_{C}) of Equation 3 under the condition that the concurrent transmission power P_{C} has a value larger than 0 and smaller than the reference transmission power P_{N}. The reference transmission power P_{N} may be, for example, 21 dBm on the basis of a 20 MHz band.

The transmission power adjustment module 24 may acquire the optimal concurrent transmission power P_{C} by repeatedly updating the optimization problem of the object function [symbol] (P_{C}) of Equation 3 until a value calculated using gradient descent as shown in Equation 4 converges.

$${P}_{C} ( t + 1 ) = {P}_{C} ( t ) - η \frac{\partial 𝕊 ( {P}_{C} )}{\partial \text{?}} \qquad [ Equation 4 ]$$

$$\text{?} \text{indicates text missing or illegible when filed}$$

Here, η is a learning rate.

When the concurrent transmission power P_{C} is calculated by the transmission power adjustment module 24, the CCA control module 25 calculates a controlled CCA threshold τ_{PD} according to the calculated concurrent transmission power P_{C}. The CCA control module 25 may calculate the controlled CCA threshold τ_{PD} in accordance with Equation 5.

$${P}_{C} = {P}_{N} + ( {τ}_{PD} - {τ}_{{PD}_{min}} ) \qquad [ Equation 5 ]$$

Here, τ_{PD}_{ₘᵢₙ} is a minimum CCA threshold (e.g., −62 dBm) defined in the IEEE 802.11 standard.

According to Equation 5, the controlled CCA threshold τ_{PD} based on the concurrent transmission power P_{C} may be set such that the sum of the calculated concurrent transmission power P_{C} and the minimum CCA threshold τ_{PD}_{ₘᵢₙ} equals the sum of the reference transmission power P_{N} and the controlled CCA threshold τ_{PD}.

As described above, the most conservative value (−82 dBm) is generally used as a CCA threshold, and for this reason, concurrent transmission is not performed even when interference occurs at a level where spatial reuse is possible.

However, according to the present disclosure, when the concurrent transmission power P_{C} is calculated, the controlled CCA threshold τ_{PD} is adjusted adaptively to the calculated concurrent transmission power P_{C}, and concurrent transmission is performed on the basis of the controlled CCA threshold τ_{PD}. Accordingly, the spatial reuse technique can be actively utilized.

The transmission determination module 26 first determines whether the concurrent transmission power P_{C} calculated by the transmission power adjustment module 24 is within a standard transmission power range (1 dBm to 21 dBm) defined in the IEEE 802.11 protocol. When the concurrent transmission power P_{C} is not within the standard transmission power range, transmission is suspended.

On the other hand, when it is determined that the concurrent transmission power P_{C} is within the standard transmission power range, the transmission determination module 26 determines whether the occupant transmission node is in an internal BSS or an external BSS on the basis of BSS information that is periodically transmitted by the AP AP1 currently occupying the channel. Whether the occupant transmission node is in the internal BSS or an external BSS may be determined by comparing a BSS color of a BSS color field 33 in the BSS color information field 32 of the frame header transmitted by the AP AP1 with BSS color of the device for spatial reuse.

When it is determined that the occupant transmission node is in the internal BSS, the transmission determination module 26 sets a reference CCA threshold τ_{ref} as a CCA threshold and determines whether to perform transmission on the basis of the set CCA threshold. As described above, according to the related art, a CCA threshold is generally set most conservatively, and thus the reference CCA threshold τ_{ref} may be, for example, −82 dBm when a channel bandwidth is 20 MHz. However, when the occupant transmission node is determined to be in an external BSS, the CCA threshold is set to the controlled CCA threshold τ_{PD} which is controlled in accordance with the concurrent transmission power P_{C}, and whether to perform transmission is determined on the basis of the set CCA threshold. In other words, depending on whether the occupant transmission node occupying the channel is in the internal BSS or an external BSS, the transmission determination module 26 sets the reference CCA threshold τ_{ref} or the controlled CCA threshold τ_{PD} as the CCA threshold for determining whether to perform transmission, and determines whether to perform transmission in accordance with the set CCA threshold.

Here, the transmission determination module 26 determines whether an RSSI measured from a signal received by the occupant transmission node is larger than the set CCA threshold. When the RSSI is larger than the CCA threshold, the transmission determination module 26 determines that the channel is in use and suspends transmission. However, when the RSSI is the CCA threshold or less, the transmission determination module 26 determines the channel to be idle and causes the transmitting module 27 to transmit a signal (or a frame) to the second station STA2 using the calculated concurrent transmission power P_{C}.

As a result, the device for spatial reuse according to the present disclosure sets the concurrent transmission power P_{C} and the CCA threshold adaptively on the basis of a density of nearby APs AP1 and determines whether to perform concurrent transmission in accordance with the set concurrent transmission power P_{C} and CCA threshold, performing concurrent transmission. Accordingly, not only the concurrent transmission power P_{C} but also the CCA threshold is adjusted adaptively. This allows very efficient utilization of the spatial reuse technique, which can improve system performance. Also, each AP independently calculates and sets concurrent transmission power P_{C} and a CCA threshold on the basis of BSS information which is periodically transmitted by nearby APs. Accordingly, there is not a large amount of information to exchange for concurrent transmission, and it is possible to prevent an increase in system overhead.

In the embodiments shown in the drawings, each element may have functions and capabilities other than those described above, and additional elements other than those described above may be included. Also, in an exemplary embodiment, each element may be implemented by one or more physically divided devices, one or more processors, or a combination of one or more processors and software. Unlike what is shown in examples, elements may not be clearly divided in terms of operation.

The device for spatial reuse shown in FIG. 2 may be implemented as hardware, firmware, software, or a combination thereof in a logic circuit or implemented using a general purpose or special purpose computer. The device may be implemented using a hardwired device, a field programmable gate array (FPGA), an application specific integrated circuit (ASIC), or the like. Also, the device may be implemented as a system on chip (SoC) including one or more processors and a controller.

In addition, the device for spatial reuse may be installed in a computing device or server with hardware elements in the form of software, hardware, or a combination thereof. The computing device or server may be various devices including all or some of a communication device, such as a communication modem, for communicating with various types of equipment or wired or wireless communication networks, a memory for storing data for executing a program, a microprocessor for executing the program for computation and instructing, and the like.

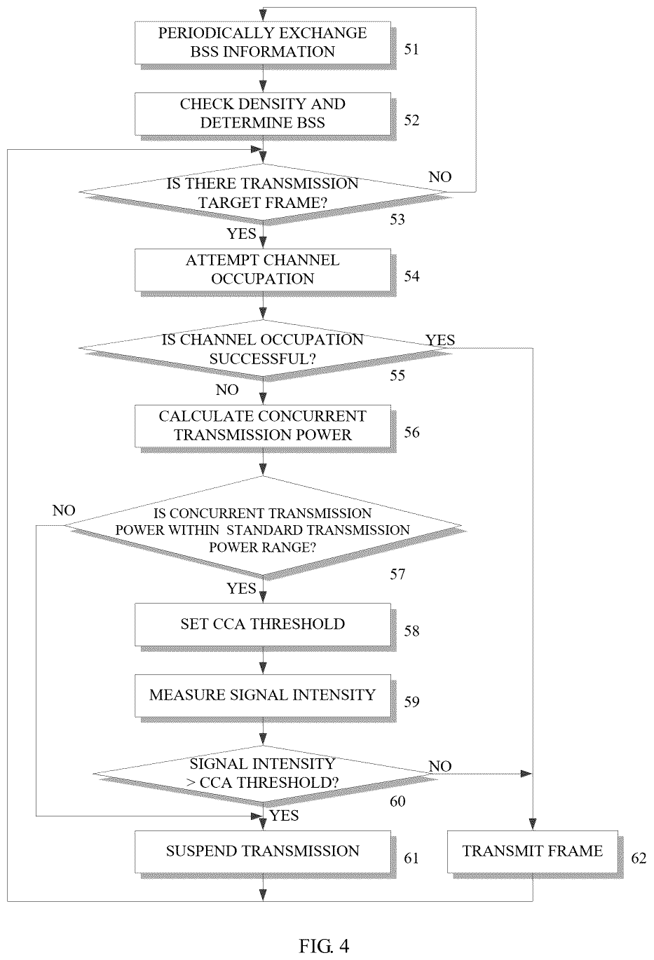

FIG. 4 is a flowchart illustrating a method for spatial reuse in a wireless network system according to an exemplary embodiment. The method for spatial reuse is likewise assumed to be performed by the APs AP1 and AP2, but the present disclosure is not limited to this case.

Referring to FIGS. 1 to 3, in the method for spatial reuse according to the present disclosure, the plurality of APs AP1 and AP2 in the wireless network periodically exchange BSS information with each other to acquire BSS information of nearby APs (51). Each of the APs AP1 and AP2 checks a density λ of nearby APs on the basis of the acquired BSS information (52). In addition, each of the APs AP1 and AP2 checks BSS color information in the BSS information to determine whether each nearby AP is an AP of an external BSS having a different BSS color than an AP of an internal BSS having the same BSS color as the AP.

Each of the APs AP1 and AP2 determines whether there is a transmission target frame to be transmitted to the station STA1 or STA2 in the same BSS (53). Here, the transmission target frame may be a frame transmitted from a server (not shown), another AP or station, or the like.

When it is determined that there is a transmission target frame, the AP performs a backoff process through the DCF of the CSMA/CA scheme to perform a channel occupation process and attempt channel occupation (54). For example, each of the APs AP1 and AP2 may attempt channel occupation by transmitting a request to send (RTS) frame. Then, the AP determines whether the channel occupation is successful (55). When the channel occupation is successful, the AP transmits the transmission target frame through the occupied channel (62). On the other hand, when the channel occupation is unsuccessful, the AP calculates concurrent transmission power P_{C} on the basis of the checked density λ of nearby APs (56). Here, the concurrent transmission power P_{C} may be calculated as power for maximizing a product of a transmission success possibility [symbol] (γ_{N}>γₜₕ) of an AP already occupying the channel and a concurrent transmission success possibility [symbol] (γ_{c}>γₜₕ) that the AP will successfully perform concurrent transmission. The concurrent transmission power P_{C} may be calculated using, for example, gradient descent.

Subsequently, each of the APs AP1 and AP2 determines whether the calculated concurrent transmission power P_{C} is within a standard transmission power range (1 dBm to 21 dBm) defined in the IEEE 802.11 protocol (57). When the concurrent transmission power P_{C} deviates from the standard transmission power range, the AP sets a network allocation vector (NAV) timer and suspends transmission (61). However, when the concurrent transmission power P_{C} is within the standard transmission power range, the AP determines whether an occupant transmission node occupying the channel is a transmission node in an internal BSS or an external BSS. When the occupant transmission node is a transmission node in the internal BSS, the AP sets a reference CCA threshold τ_{ref} as a CCA threshold as before. However, when the occupant transmission node is a transmission node in an external BSS, a controlled CCA threshold τ_{PD} which is controlled in accordance with the concurrent transmission power P_{C} is calculated and set as a CCA threshold (58). Here, the controlled CCA threshold τ_{PD} may be set such that the sum of the concurrent transmission power P_{C} and a minimum CCA threshold τ_{PD}_{ₘᵢₙ} equals the sum of a reference transmission power P_{N} that is a transmission power of the transmission node occupying the channel and the controlled CCA threshold τ_{PD}. The reference CCA threshold τ_{ref} may be included in the BSS information which is transmitted by nearby APs and acquired.

When the CCA threshold is set, each of the APs AP1 and AP2 measures an intensity of a signal transmitted by the occupant transmission node occupying the channel (59). Then, the AP determines whether the measured intensity of the signal exceeds the set CCA threshold (60). When the measured intensity of the signal exceeds the set CCA threshold, the AP suspends transmission (61). On the other hand, when the measured intensity of the signal is the set CCA threshold or less, the AP concurrently transmits a frame to the station while the occupant transmission node is occupying the channel and performing transmission (62).

Although it has been described that operations of FIG. 4 are sequentially performed, this is illustrative, and those of ordinary skill in the art may variously alter and modify the operations by changing the order illustrated in FIG. 4, performing two or more operations in parallel, or adding another operation without departing from the fundamental characteristics of the exemplary embodiment of the present invention.

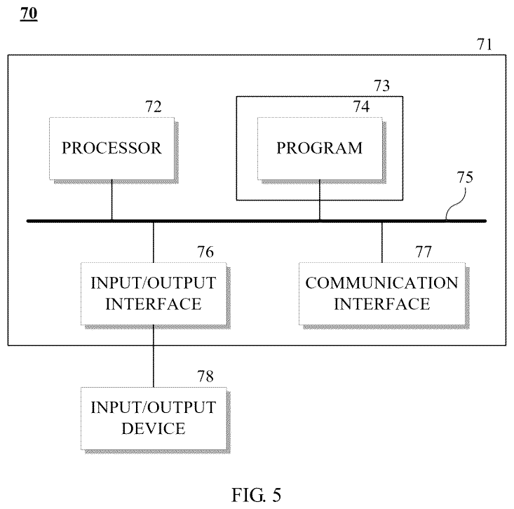

FIG. 5 is a diagram illustrating a computing environment including a computing device according to an exemplary embodiment.

In the exemplary embodiment shown in the drawing, each component may have functions and capabilities other than those described below, and additional components other than those described below may be included. A computing environment 70 shown in the drawing may include a computing device 71 to perform the method for spatial reuse shown in FIG. 4. According to the exemplary embodiment, the computing device 71 may be one or more components included in the device for spatial reuse shown in FIG. 2.

The computing device 71 includes at least one processor 72, a computer-readable storage medium 73, and a communication bus 75. The processor 72 may cause the computing device 71 to operate according to the foregoing exemplary embodiment. For example, the processor 72 may execute one or more programs 74 stored in the computer-readable storage medium 73. The one or more programs 74 may include one or more computer-executable instructions, and the computer-executable instructions may be configured to cause the computing device 71 to perform operations according to the exemplary embodiment when executed by the processor 72.

The communication bus 75 connects various components of the computing device 71 including the processor 72 and the computer-readable storage medium 73 to each other.

The computing device 71 may also include at least one input/output interface 76 which provides an interface for at least one input/output device 78 and at least one communication interface 77. The input/output interface 76 and the communication interface 77 are connected to the communication bus 75. The input/output device 78 may be connected to other components of the computing device 71 through the input/output interface 76. The exemplary input/output device 78 may include input devices, such as a pointing device (a mouse, a trackpad, or the like), a keyboard, a touch input device (a touchpad, a touchscreen, or the like), a voice or sound input device, various types of sensor devices, and/or an imaging device, and/or output devices such as a display device, a printer, a speaker, and/or a network card. The exemplary input/output device 78 may be included in the computing device 71 as a component of the computing device 71 or connected to the computing device 71 as a device separate from the computing device 71.

With a device and method for spatial reuse according to the present disclosure, transmission power is adjusted on the basis of the density of nearby APs. Accordingly, it is possible to not only prevent an increase in system overhead by exchanging few frames but also maximize a success rate of concurrent transmission with existing transmission. Also, a CCA threshold is adjusted adaptively to determined transmission power, which allows efficient spatial reuse.

Although the present invention has been described above with reference to the exemplary embodiments, those of ordinary skill in the art should understand that various modifications and other equivalent embodiments can be made from the embodiments. Therefore, the technical scope of the present invention should be determined from the technical spirit of the following claims.

What is claimed is:

1. A device for spatial reuse included in a transmission node of a wireless network, the device comprising:
a memory; and
a processor configured to execute at least some of operations based on a program stored in the memory,
wherein the processor calculates concurrent transmission power that is a power for transmitting a signal concurrently with an occupant transmission node, which is occupying a channel and transmitting a signal with reference transmission power, on the basis of a density of nearby access points (APs), adjusts and sets a clear channel assessment (CCA) threshold in accordance with the concurrent transmission power, and determines whether to perform concurrent transmission in accordance with the CCA threshold and an intensity of the signal transmitted by the occupant transmission node.

2. The device of claim 1, wherein the processor calculates and acquires the concurrent transmission power for maximizing a product of a transmission success possibility of the occupant transmission node and a concurrent transmission success possibility which is a transmission success possibility of concurrent transmission.

3. The device of claim 1, wherein, when the concurrent transmission power is not within a standard transmission power range, the processor causes the transmission node to not perform concurrent transmission by suspending transmission.

4. The device of claim 1, wherein, when a signal intensity transmitted by the occupant transmission node is the CCA threshold or less, the processor causes the transmission node to perform concurrent transmission.

5. The device of claim 1, wherein, when the occupant transmission node is an internal basic service set (BSS) node constituting a BSS with the transmission node, the processor sets a reference CCA threshold as the CCA threshold.

6. The device of claim 1, wherein, when the occupant transmission node is an external basic service set (BSS) node constituting a different BSS than the transmission node, the processor sets the CCA threshold such that a sum of the concurrent transmission power and a minimum CCA threshold equals a sum of the reference transmission power and the CCA threshold.

7. The device of claim 1, wherein the processor checks the density of the nearby APs on the basis of basic service set (BSS) information which is periodically exchanged between the APs and acquired.

8. The device of claim 1, wherein the processor determines whether the occupant transmission node is an internal basic service set (BSS) node included in the same BSS as the transmission node or an external BSS node included in a different BSS than the transmission node on the basis of BSS color information included in BSS information which is periodically exchanged between the APs and acquired.

9. The device of claim 1, wherein the transmission node is implemented as a device for occupying the channel using a distribution coordination function (DCF) of a carrier sense multiple access/collision avoidance (CSMA/CA) scheme based on Institute of Electrical and Electronics Engineers (IEEE) 802.11.

10. A method for spatial reuse performed by a processor included in a transmission node of a wireless network, the method comprising:
calculating concurrent transmission power that is a power for transmitting a signal concurrently with an occupant transmission node, which is occupying a channel and transmitting a signal with reference transmission power, on the basis of a density of nearby access points (APs);
adjusting and setting a clear channel assessment (CCA) threshold in accordance with the concurrent transmission power; and
determining whether to perform concurrent transmission according to the CCA threshold and an intensity of the signal transmitted by the occupant transmission node.

11. The method of claim 10, wherein the calculating of the concurrent transmission power comprises calculating and acquiring the concurrent transmission power for maximizing a product of a transmission success possibility of the occupant transmission node and a concurrent transmission success possibility which is a transmission success possibility of concurrent transmission.

12. The method of claim 10, wherein the determining of whether to perform concurrent transmission comprises, when the concurrent transmission power is not within a standard transmission power range, suspending, by the transmission node, transmission to not perform concurrent transmission.

13. The method of claim 10, wherein the determining of whether to perform concurrent transmission comprises, when a signal intensity transmitted by the occupant transmission node is the CCA threshold or less, performing, by the transmission node, concurrent transmission.

14. The method of claim 10, wherein the adjusting and setting of the CCA threshold comprises, when the occupant transmission node is an internal basic service set (BSS) node constituting a BSS with the transmission node, setting a reference CCA threshold as the CCA threshold.

15. The method of claim 10, wherein the adjusting and setting of the CCA threshold comprises, when the occupant transmission node is an external basic service set (BSS) node constituting a different BSS than the transmission node, setting the CCA threshold such that a sum of the concurrent transmission power and a minimum CCA threshold equals a sum of the reference transmission power and the CCA threshold.

16. The method of claim 10, wherein the calculating of the concurrent transmission power comprises checking the density of the nearby APs on the basis of basic service set (BSS) information which is periodically exchanged between the APs and acquired.

17. The method of claim 10, wherein the determining of whether to perform concurrent transmission comprises determining whether the occupant transmission node is an internal basic service set (BSS) node included in the same BSS as the transmission node or an external BSS node included in a different BSS than the transmission node on the basis of BSS color information included in BSS information which is periodically exchanged between the APs and acquired.

18. The method of claim 10, wherein the transmission node is implemented as a device for occupying the channel using a distribution coordination function (DCF) of a carrier sense multiple access/collision avoidance (CSMA/CA) scheme based on Institute of Electrical and Electronics Engineers (IEEE) 802.11.
